(19) United States
(12) Patent Application Publication
(10) Pub. No.: US 2025/0330098 A1
(43) Pub. Date: Oct. 23, 2025

(54) LOW INRUSH CURRENT POWER CONVERTER CIRCUIT

(71) Applicant: TEXAS INSTRUMENTS INCORPORATED, Dallas, TX (US)

(72) Inventors: Mohamed AHMED, Merrimack, NH (US); Bharath Balaji KANNAN, Merrimack, NH (US); Michael CORRY, Plano, TX (US); Usama ANWAR, Brooklyn, NY (US)

(21) Appl. No.: 18/643,401

(22) Filed: Apr. 23, 2024

(51) Int. Cl. H02M 3/335; H02M 1/00

(52) U.S. Cl. CPC H02M 3/33573; H02M 1/0012

(57) ABSTRACT

In examples, a circuit comprises a transformer including first and second windings forming an isolation barrier. The circuit includes a first controller coupled to the second winding, a rectifier, and an output of the circuit, the first controller configured to generate a signal indicating a voltage on the output. The circuit comprises a second controller coupled to the first winding and switches and separated from the first controller by the isolation barrier, the second controller configured to operate the switches to have a capped, variable duty cycle, to have an uncapped, variable duty cycle, or to maintain the voltage within a hysteresis band, responsive to the signal.

### BACKGROUND

Power converter circuits convert electrical energy from one form to another. For example, DC-DC power converter circuits receive an input DC voltage and provide an output DC voltage that differs from the input DC voltage. For instance, buck converters may step down voltages while boost converters may step up voltages. Power converter circuits may be implemented in a variety of systems to meet the specific power requirements of those systems.

### SUMMARY

In examples, a circuit comprises a transformer including first and second windings forming an isolation barrier. The circuit includes a first controller coupled to the second winding, a rectifier, and an output of the circuit, the first controller configured to generate a signal indicating a voltage on the output. The circuit comprises a second controller coupled to the first winding and switches and separated from the first controller by the isolation barrier, the second controller configured to operate the switches to have a capped, variable duty cycle, to have an uncapped, variable duty cycle, or to maintain the voltage within a hysteresis band, responsive to the signal.

### BRIEF DESCRIPTION OF THE DRAWINGS

FIG. 1 is a block diagram of an electronic device implementing a low inrush current power converter circuit, in accordance with various examples.

FIG. 2 is a schematic diagram of a low inrush current power converter circuit, in accordance with various examples.

FIG. 3 is a schematic diagram of a set of switches in a low inrush current power converter circuit, in accordance with various examples.

FIG. 4 is a block diagram of a controller in a low inrush current power converter circuit, in accordance with various examples

FIG. 5 is a schematic diagram of a rectifier in a low inrush current power converter circuit, in accordance with various examples.

FIG. 6 is a block diagram of a controller in a low inrush current power converter circuit, in accordance with various examples.

FIG. 7 is a flow diagram of a method for operating a low inrush current power converter circuit, in accordance with various examples.

FIG. 8 is a timing diagram indicating the behavior of signals produced by a low inrush current power converter circuit, in accordance with various examples.

FIG. 9 is a schematic diagram of a voltage comparison circuit in a low inrush current power converter circuit, in accordance with various examples.

FIG. 10 is a schematic diagram of a transformer switching detection circuit in a low inrush current power converter circuit, in accordance with various examples.

FIG. 11 is a schematic diagram of an encoding circuit in a low inrush current power converter circuit, in accordance with various examples.

FIG. 12 is a schematic diagram of a decoding circuit in a low inrush current power converter circuit, in accordance with various examples.

FIG. 13 is a schematic diagram of a decoding circuit in a low inrush current power converter circuit, in accordance with various examples.

FIGS. 14 and 15 are graphs indicating the operation of a low inrush current power converter circuit, in accordance with various examples.

### DETAILED DESCRIPTION

In many power converter circuits, a capacitor is coupled across the output terminals of the circuit to smooth the output voltage provided by the circuit. More specifically, the capacitor is useful to filter high-frequency noise or ripple present in the output voltage that may be introduced, for example, by the switching action of the circuit. Although the capacitor is limited in the maximum charge it can hold during steady state operation, during startup of the circuit, the capacitor may not be holding any charge. Consequently, the capacitor is able to charge rapidly, with the circuit output voltage rising quickly and the input current to the circuit also rising quickly. The input current may rise so high during startup of the circuit (e.g., up to three times the input current drawn during steady state operation) that oversized front-end power supplies are required to provide the input current to the power converter circuit. Providing oversized front-end power supplies is undesirable at least because it increases manufacturing cost and product size. In addition, large inrush currents can damage circuitry in the front-end power supply, in the power converter, or both.

Prior attempts to mitigate high inrush currents in power converter circuits have failed. Some such attempts have reduced inrush current to a modest degree, but the results are inconsistent and high inrush currents remain a technical challenge, particularly before the power converter circuit has reached regulation mode (e.g., an operation mode in which the power converter circuit periodically enables and disables switching action to maintain the output voltage within a defined hysteresis band). In other attempts, startup of the power converter circuit remains a technical challenge, as the startup may occur soon after the power converter was shut off, and the capacitor has not been completely discharged. In such cases, the controller of the power converter circuit operates at startup under the assumption that the capacitor is completely discharged, but because the capacitor still retains some charge from prior use, the circuit suffers from output voltage overshoot. Such overshoot can damage components receiving power from the power converter circuit. Prior attempts at mitigation of high inrush currents are also technically deficient because they implement cross-isolation barrier communication schemes that demand high quiescent currents, which contribute to operational inefficiency, particularly when the power converter circuit load is light.

Prior attempts also fail to appropriately react to short circuits in the power converter circuit. In the case of a short circuit, the power converter circuit will operate as normal, resulting in a massive inrush current, with the attendant technical disadvantages described above.

This disclosure describes various examples of a low inrush current power converter circuit that mitigates the technical challenges described above. More specifically, each example power converter circuit described herein includes controllers that assess the status of the power converter circuit (e.g., the output voltage of the power converter circuit) immediately upon startup and selectively enable different operation modes for the power converter circuit depending on the assessment. The circuit may directly enter any of the various operation modes after the assessment, without having to sequentially progress through the modes. Because the power converter circuit enables its operation modes based on output voltage measurements rather than on assumptions about the output voltage, the circuit mitigates the various technical challenges described above.

For example, upon startup, the controllers of the power converter circuit may immediately assess the status of the circuit and determine that no status indicator is available. Consequently, the controllers may enable a first operation mode, in which the controllers tightly control the power converter circuit switching duty cycle. Limiting the duty cycle in this manner prevents overcharging of the output capacitor (which could result in high inrush current) and further prevents high inrush current in the setting of a short circuit in the power converter circuit.

Upon startup, the controllers may determine that the status indicator is indicating the output voltage is above a first threshold but below a second threshold. The fact that the output voltage has exceeded the first threshold means that there is likely no short circuit in the power converter circuit, and thus it is safe to remove constraints on the switching duty cycle. Thus, the controllers may enable a second operation mode, in which the switching duty cycle continues to be incremented, but now, there are no duty cycle constraints. So long as the status indicator indicates that the output voltage remains in between the first and second thresholds, the power converter circuit continues to operate in the second operation mode.

Upon startup, the controllers may determine that the status indicator is indicating the output voltage is above the second threshold voltage. This means that the output voltage has reached a regulation mode, such that the output voltage approximates the target steady state output voltage. Consequently, the controllers enable a third operation mode, in which the switching action is enabled when the output voltage reaches the lower boundary of a hysteresis band and is disabled when the output voltage reaches the upper boundary of the hysteresis band. In this way, the output voltage is maintained within the hysteresis band. By dynamically and selectively enabling the operation mode of the power converter circuit based on the output voltage immediately upon startup, situations that typically result in large inrush currents, such as those common to the prior solutions described above, are avoided altogether.

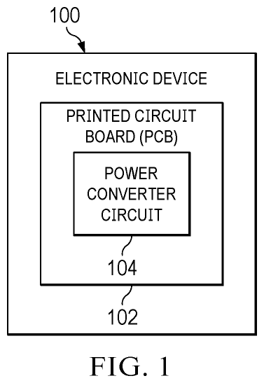

FIG. 1 is a block diagram of an electronic device implementing a low inrush current power converter circuit, in accordance with various examples. In particular, FIG. 1 depicts an electronic device 100, which may be any suitable type of electronic device, such as a smartphone, a laptop computer, a desktop computer, a notebook, a tablet, an appliance (e.g., kitchen appliance), a television, heating or cooling products, an automobile, a watercraft, an aircraft, a spacecraft, etc. The device 100 may include a printed circuit board (PCB) 102 to which various circuitry is coupled. A low inrush current power converter circuit (PCC) 104 may be coupled to the PCB 102. Examples of the power converter circuit 104 are described herein.

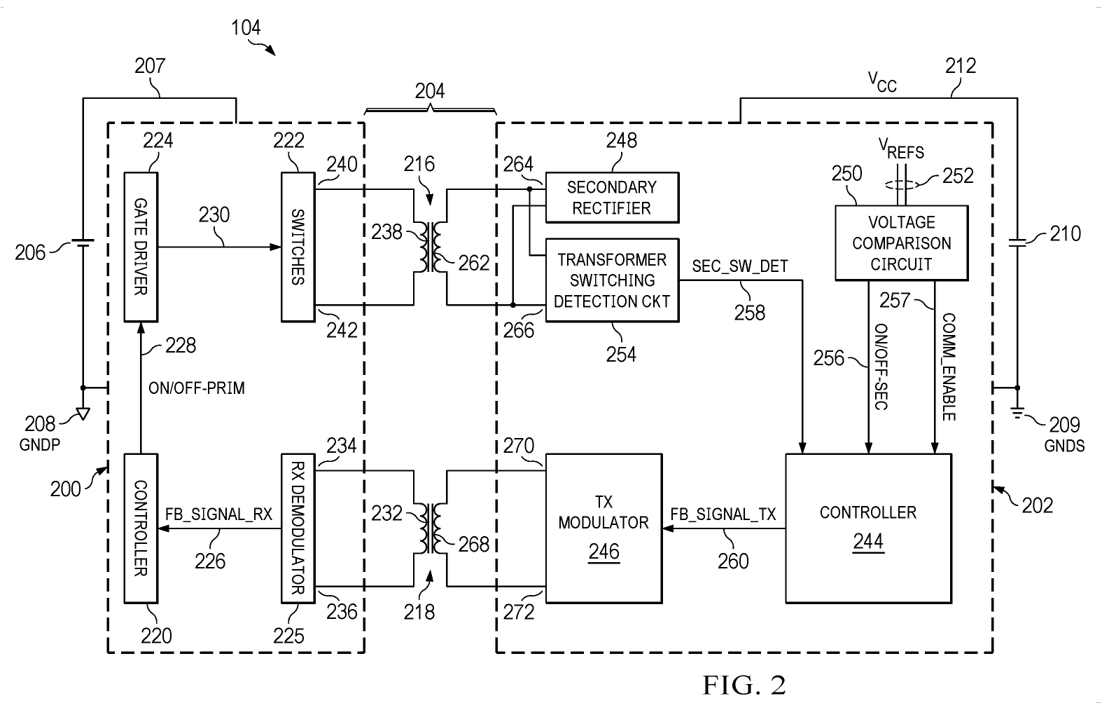

FIG. 2 is a schematic diagram of a PCC 104, in accordance with various examples. The PCC 104 may include a primary side 200 and a secondary side 202 separated by a transformer isolation barrier 204. A power supply 206, such as a voltage source, is coupled to the primary side 200 and provides voltage (and current) to the primary side 200. The power supply 206 is coupled to a positive terminal 207 and a ground terminal 208. A capacitor 210 is coupled to the secondary side 202. For example, the capacitor 210 may be coupled in parallel with a load (not expressly shown) that is coupled to a positive terminal 212 and a ground terminal 209. The capacitor 210 may have any suitable capacitance, depending upon the particular application in which the PCC 104 is deployed. The primary side 200 provides power to the secondary side 202 by way of a transformer 216, as described in detail below. The secondary side 202 communicates data to the primary side 200 by way of a transformer 218, as described in detail below.

The primary side 200 may include a controller 220. The controller 220 may include any combination of analog circuitry, digital circuitry, processors, memory, and/or executable instructions as may be suitable to perform the actions attributed herein to the controller 220. Example contents of the controller 220 are described below. The primary side 200 may include a set of switches 222 (e.g., configured in a bridge topology) and a gate driver 224 coupled to the controller 220 and to the switches 222 (e.g., to gate terminals of field effect transistor (FET) switches 222). Furthermore, the primary side 200 may include a demodulator 225 that is coupled to the controller 220. Any suitable connection topology may be useful to couple the components of the primary side 200 to each other. In at least some examples, a connection 226 couples the demodulator 225 to the controller 220, a connection 228 couples the controller 220 to the gate driver 224, and a connection 230 couples the gate driver 224 to the switches 222. Each connection described herein may include one or more physical connections (e.g., metal traces). The connection 226 provides a signal FB_SIGNAL_RX from the demodulator 225 to the controller 220. The connection 228 provides a signal ON/OFF-PRIM from the controller 220 to the gate driver 224. The connection 230 provides switching signals from the gate driver 224 to the switches 222. A winding 232 of the transformer 218 is coupled to the demodulator 225 by way of terminals 234 and 236. A winding 238 of the transformer 216 is coupled to the switches 222 by way of terminals 240 and 242.

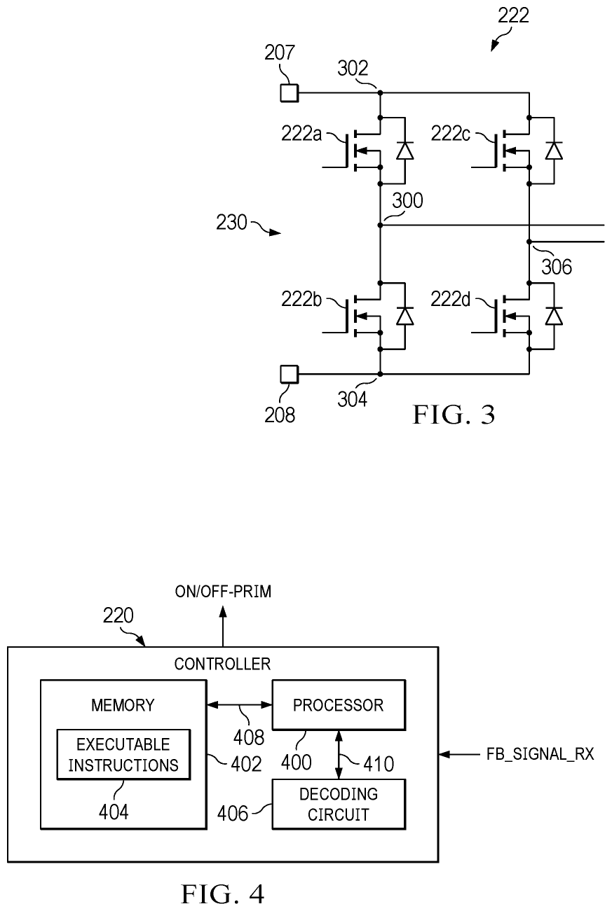

Referring briefly to FIG. 3, an example circuit diagram of the switches 222 is shown. The switches 222 include switches (e.g., FETs) 222a-222d coupled in a bridge topology, for example. The switches 222a and 222b may couple at a node 300. The switches 222a and 222c may couple at a node 302. The switches 222b and 222d may couple at a node 304. The switches 222c and 222d may couple at a node 306. The nodes 300 and 306 may be considered “switching nodes,” with node 300 coupled to terminal 240 (FIG. 2) and node 306 coupled to terminal 242 (FIG. 2). Node 302 is coupled to positive terminal 207 (FIGS. 2 and 3) and node 304 is coupled to ground terminal 208 (FIGS. 2 and 3). Connection 230 is shown in FIGS. 2 and 3 are a single connection, but in examples, the connection 230 may be multiple connections, one connection for the gate terminal of each switch 222a-222d. In this way, the switches 222a-222d may be controlled individually. In examples, the switches 222a and 222d may be turned on while the switches 222b and 222c are turned off, thus connecting the terminal 240 (FIG. 2) to the positive terminal 207 and the terminal 242 (FIG. 2) to the ground terminal 208. Similarly, the switches 222a and 222d may be turned off while the switches 222b and 222c are turned on, thus connecting the terminal 240 (FIG. 2) to the ground terminal 208 and the terminal 242 (FIG. 2) to the positive terminal 207. In this way, the voltage across terminals 240, 242 alternates back and forth in polarity, inducing an alternating current in the winding 238 to generate an electromagnetic field.

Referring briefly to FIG. 4, a block diagram of an example controller 220 is shown. As mentioned above, the controller 220 may include any combination of analog circuitry, digital circuitry, processors, memory, and/or executable instructions as may be suitable to perform the actions attributed herein to the controller 220. In the example of FIG. 4, the controller 220 includes a processor 400, a memory 402 (e.g., a non-transitory, computer-readable medium such as random access memory (RAM)), executable instructions 404 stored on the memory 402, and a decoding circuit 406. A connection 408 couples the processor 400 to the memory 402. A connection 410 couples the processor 400 to the decoding circuit 406. The controller 220 receives the signal FB_SIGNAL_RX and provides the signal ON/OFF-PRIM, as shown. Any combination of the components shown in FIG. 4 may perform some or all of the actions attributed herein to the controller 220. Example contents of the decoding circuit 406 and example operations of the controller 220 are described below.

Referring again to FIG. 2, in operation, a current induced in the winding 232 (as described below) is provided to the demodulator 225, which demodulates the current to determine the data encoded in the current. The demodulator 225 produces the signal FB_SIGNAL_RX indicating the data. The controller 220 receives FB_SIGNAL_RX and decodes the signal to produce signal ON/OFF-PRIM, and the controller 220 controls the gate driver 224 accordingly using ON/OFF-PRIM. The gate driver 224 controls individual ones of the switches 222 based on ON/OFF-PRIM. The switching action of the switches 222 energizes the winding 238, forming an electromagnetic field in the transformer 216 and providing power across the isolation barrier 204.

Referring still to FIG. 2, the secondary side 202 may include a controller 244. The controller 244 may include any combination of analog circuitry, digital circuitry, processors, memory, and/or executable instructions as may be suitable to perform the actions attributed herein to the controller 244. Examples contents of the controller 244 are described below. The secondary side 202 further includes a modulator 246, a rectifier 248, a voltage comparison circuit 250 having reference voltage (V_{REF}) inputs coupled to connections 252, and a transformer switching detection circuit 254. A connection 256 couples the voltage comparison circuit 250 to the controller 244 and provides a signal ON/OFF-SEC, and a connection 257 couples the voltage comparison circuit 250 to the controller 244 to provide a signal COMM_ENABLE. A connection 258 couples the transformer switching detection circuit 254 to the controller 244 and provides a signal SEC_SW_DET. A connection 260 couples the controller 244 to the modulator 246 and provides the signal FB_SIGNAL_TX. Various components in the secondary side 202 are coupled to the positive terminal 212 and/or the ground terminal 209, including the secondary rectifier 248 and the voltage comparison circuit 250, as described below. The secondary side 202 may further include a winding 262 of the transformer 216 that is coupled to the secondary rectifier 248 by way of terminals 264 and 266, and that is also coupled to the transformer switching detection circuit 254 by way of the terminals 264 and 266. The secondary side 202 further includes a winding 268 of the transformer 218, which is coupled to the modulator 246 by way of terminals 270 and 272.

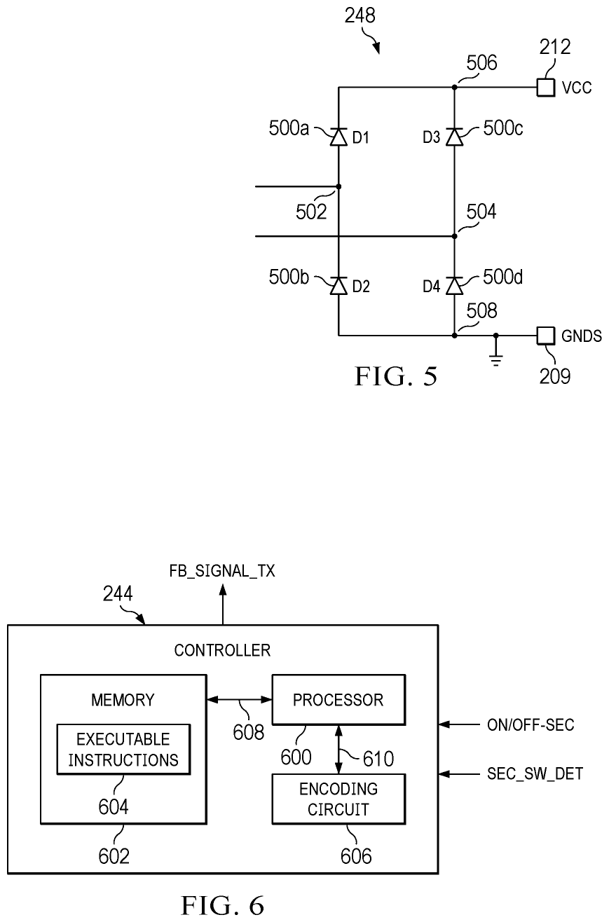

Referring briefly to FIG. 5, the rectifier 248 may include multiple diodes (e.g., diodes 500a-500d) configured in a bridge topology. The diodes 500a and 500b may be coupled by a node 502, and the diodes 500c and 500d may be coupled by a node 504. The diodes 500a and 500c may be coupled by a node 506, and the diodes 500b and 500d may be coupled by a node 508. The nodes 502 and 504 may couple to terminals 264 and 266 (FIG. 2), respectively. The node 506 may couple to the positive terminal 212, and the node 508 may couple to the ground terminal 209. When the polarity of the voltage across nodes 502, 504 is positive, diodes 500a and 500d turn on, while diodes 500b and 500c turn off, thus providing a voltage with positive polarity across terminals 212, 209. Conversely, when the polarity of the voltage across nodes 502, 504 is negative, diodes 500a and 500d turn off, while diodes 500b and 500c turn on, thus again providing a voltage with positive polarity across terminals 212, 209. Thus, regardless of the polarity of the voltage across nodes 502, 504 (which is repeatedly changing during switching action of the switches 222 to generate the electromagnetic field in transformer 216), the voltage polarity across terminals 212, 209 remains positive.

Referring briefly to FIG. 6, a block diagram of an example controller 244 is shown. As mentioned above, the controller 244 may include any combination of analog circuitry, digital circuitry, processors, memory, and/or executable instructions as may be suitable to perform the actions attributed herein to the controller 244. In the example of FIG. 6, the controller 244 includes a processor 600, a memory 602 (e.g., a non-transitory, computer-readable medium, such as random access memory (RAM)), executable instructions 604 stored on the memory 602, and an encoding circuit 606. A connection 608 couples the processor 600 to the memory 602. A connection 610 couples the processor 600 to the encoding circuit 606. The controller 244 receives the signals ON/OFF-SEC and SEC_SW_DET and provides the signal FB_SIGNAL_TX, as shown. Any combination of the components shown in FIG. 6 may perform some or all of the actions attributed herein to the controller 244. Example contents of the encoding circuit 606 and example operations of the controller 244 are described below.

Referring again to FIG. 2, in operation, a current induced in the winding 262 is provided to the rectifier 248. Because of the switching action of the switches 222, the current induced in the winding 262 is an alternating current, and the rectifier 248 converts the alternating current to direct current (DC). The rectifier 248 provides a DC voltage across the positive terminal 212 and the ground terminal 209. This DC voltage is the output voltage V_{CC} of the PCC 104. The output voltage V_{CC} is provided across the capacitor 210 and charges the capacitor 210. Because V_{CC} is a DC voltage provided by the rectifier 248, the capacitor 210 continually charges when the switches 222 are switching, regardless of the polarity of the voltage provided at the terminals 240, 242 or the direction of the current flowing through the winding 238. When the switches 222 cease switching, the capacitor 210 continually discharges. As described above, the controllers of the PCC 104 (e.g., the controllers 220, 244) enable specific operation modes of the PCC 104 based on an assessment of the output voltage V_{CC}. The voltage comparison circuit 250 detects V_{CC}, compares V_{CC} to one or more reference voltages V_{REF}, and provides ON/OFF-SEC to the controller 244 accordingly. The voltage comparison circuit 250 also provides to the controller 244 the signal COMM_ENABLE, which indicates whether a status indicator signal can be provided from the secondary side 202 to the primary side 200. The transformer switching detection circuit 254 determines whether the transformer 216 is switching current direction at a given time (i.e., whether the switches 222 are actively switching), with SEC_SW_DET indicating to the controller 244 whether the transformer 216 is switching. Based on ON/OFF-SEC, COMM_ENABLE, and SEC_SW_DET, the controller 244 prepares the signal FB_SIGNAL_TX, which indicates the PCC 104 operation mode that the controller 220 should enable and whether the controller 220 should start or stop switching action of the switches 222 to maintain V_{CC} within a hysteresis band defined by the V_{REF} signals provided on connections 252. The modulator 246 receives FB_SIGNAL_TX and modulates the signal on the winding 268 via terminals 270, 272, thus forming an electromagnetic field in the transformer 218 for provision of FB_SIGNAL_TX to the modulator 225 across the isolation barrier 204. The controller 220 receives the communication from the controller 244 and controls the switches 222 accordingly. The operation mode instructed by the controller 244 to the controller 220 informs the specific manner in which the controller 220 controls the switches 222, as described below.

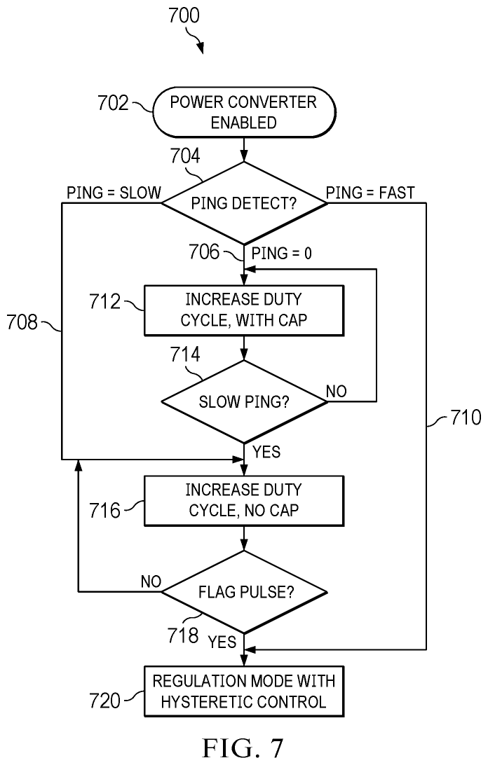

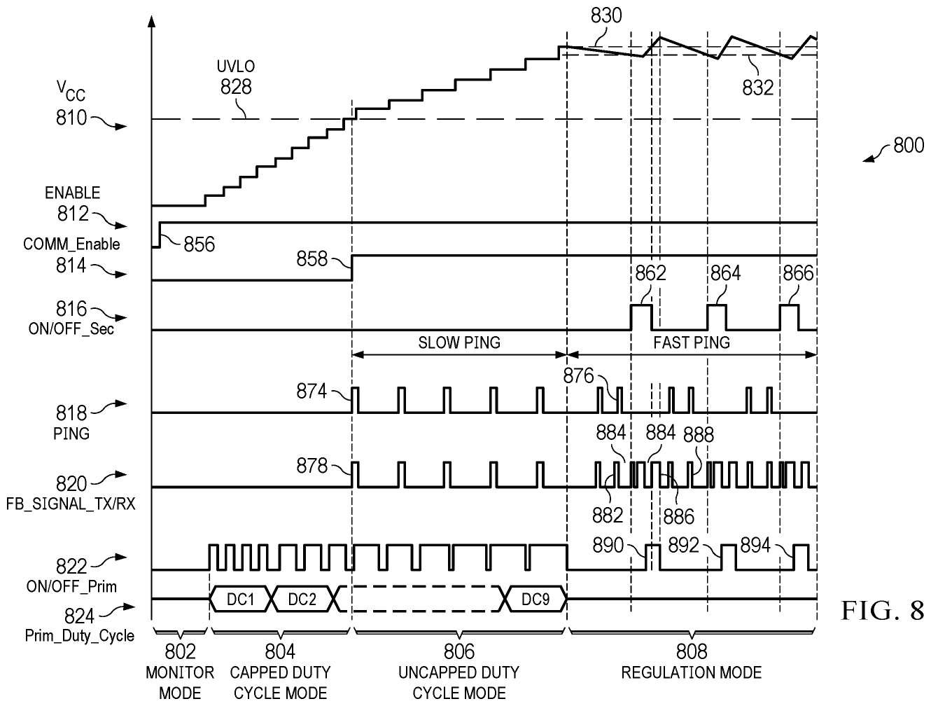

FIG. 7 is a flow diagram of a method 700 for operating a low inrush current power converter circuit, in accordance with various examples. The method 700 may be performed by the controller 220. Alternatively, the method 700 may be performed by multiple components within the PCC 104, in which case the PCC 104 may be said to perform the method 700. Some operations of the method 700 may be performed by other components or entities external to the PCC 104. FIG. 8 is a timing diagram 800 indicating the behavior of signals produced by a low inrush current power converter circuit, in accordance with various examples. FIGS. 7 and 8 are described in parallel, with occasional reference to the schematic diagram of FIG. 2.

Before operations of the method 700 are described, the layout of the timing diagram 800 is described. The timing diagram 800 depicts the behavior of various signals in the PCC 104. At the bottom of the timing diagram 800, multiple operation modes of the PCC 104 are shown. Specifically, the timing diagram 800 depicts a monitor mode 802, a capped duty cycle mode 804, an uncapped duty cycle mode 806, and a regulation mode 808. During the monitor mode 802, the controller 220 receives and assesses a PING signal received from the controller 244 in FB_SIGNAL_RX. The PING signal is based on the status of V_{CC}. For example, based on the frequency of the PING signal, the controller 220 enables either the mode 804, the mode 806, or the mode 808. The controller 220 enables the mode 804 when the PING signal frequency is zero, which is an indication from the controller 244 that V_{CC} is either low, or the status of V_{CC} is unknown. In mode 804, the controller 220 begins switching action of the switches 222 with a gradually increasing duty cycle, but the duty cycle is capped at a maximum value that is not exceeded while in mode 804. The controller 220 enables the mode 806 when the PING signal frequency is above zero but below a threshold frequency, which is an indication from the controller 244 that V_{CC} has reached a voltage threshold and thus there is no short circuit present in the PCC 104. In mode 806, the controller 220 continues the switching action of the switches 222 with a gradually increasing duty cycle, but the duty cycle is no longer capped at a maximum value, because the controller 220 has confirmation that no short circuit exists in the PCC 104. The controller 220 enables the mode 808 when the PING signal frequency is above the threshold frequency, which is an indication from the controller 244 that V_{CC} has reached the target hysteresis band. In mode 808, the controller 220 turns on and turns off the switching action of the switches 222 according to instructions received from the controller 244 to maintain V_{CC} within the target hysteresis band. The controller 244 sends these instructions to the controller 220 together with the PING signal, both of which are encoded on FB_SIGNAL_TX and FB_SIGNAL_RX. The operation modes 802, 804, 806, and 808 are described in detail below.

The timing diagram 800 also includes a signal 810, which is the output voltage V_{CC} of the PCC 104; an ENABLE signal 812, which indicates whether the PCC 104 is enabled and which may be generated by a component outside of the PCC 104 (e.g., coupled to the same PCB 102 (FIG. 1) as the PCC 104) to turn on or off a switch (not expressly shown) between the power supply 206 and the positive terminal 207; a COMM_ENABLE signal 814, which indicates whether communications between the primary side 200 and the secondary side 202 are enabled; the ON/OFF-SEC signal 816, which is the ON/OFF-SEC signal on connection 256 of the PCC 104 and which indicates whether V_{CC} is within the target hysteresis band, and thus whether the switches 222 should be switching; a PING signal 818, which is a signal generated by the controller 244 to indicate the operation mode in which the PCC 104 should operate based at least on the status of V_{CC}; a signal 820, which is the FB_SIGNAL_TX signal (provided by the controller 244 to the modulator 246 and from the modulator 246 to the demodulator 225), and which is identical to the FB_SIGNAL_RX signal (provided from the demodulator 225 to the controller 220), and which is a logic OR combination of the ON/OFF-SEC signal 816 and PING signal 818; the ON/OFF-PRIM signal 822, which is provided by the controller 220 to the gate driver 224 to operate the switches 222; and a PRIM_DUTY_CYCLE signal 824, which indicates duty cycle changes in the ON/OFF-PRIM signal 822. Of the signals depicted in the timing diagram 800, the PRIM_DUTY_CYCLE signal 824 is provided to facilitate understanding for the reader and may not necessarily be a signal implemented in the PCC 104. The various signals shown in the timing diagram 800 are described in detail below.

The method 700 begins with enabling the PCC 104 (702). Any suitable entity, such as another component coupled to the PCB 102 (FIG. 1), may provide the ENABLE signal (e.g., signal 812) to activate the power supply 206 and/or to turn on a switch that could be placed on the electrical pathway between the power supply 206 and the PCC 104. In FIG. 8, the ENABLE signal 812 rises from low to high to enable the PCC 104, as numeral 856 indicates. For example, the ENABLE signal 812 may be generated by another component on the PCB 102 (FIG. 1) and may be provided to a gate terminal of a switch positioned on the positive terminal 207, and thus when the enable signal 812 goes high, the power supply 206 is electrically coupled to the PCC 104 and provides power to the PCC 104.

The method 700 further includes detecting the PING signal provided by the secondary side 202 to the primary side 200 (704). Step 704 corresponds to the monitor mode 802 shown in the timing diagram 800 of FIG. 8. During the monitor mode 802, the controller 220 receives the signal FB_SIGNAL_RX (signal 820) from the controller 244 and separates the FB_SIGNAL_RX signal into its constituent components, the ON/OFF-SEC signal 816 and the PING signal 818. The frequency of the PING signal 818 indicates to the controller 220 the operation mode of the PCC 104 that should be enabled based on the status of the secondary side 202, such as the status of V_{CC}. The generation and transmission of the PING signal 818 is now described, after which the description of the method 700 will resume.

To generate the PING signal 818, the controller 244 uses the ON/OFF-SEC and COMM_ENABLE signals from the voltage comparison circuit 250 and the SEC_SW_DET signal from the transformer switching detection circuit 254. The ON/OFF-SEC signal indicates when the switching action of the switches 222 should be started or stopped to maintain V_{CC} within the target hysteresis band of the PCC 104. The COMM_ENABLE signal indicates when the PING signal 818 may be provided to the controller 220. The SEC_SW_DET signal indicates when the switches 222 are actively switching.

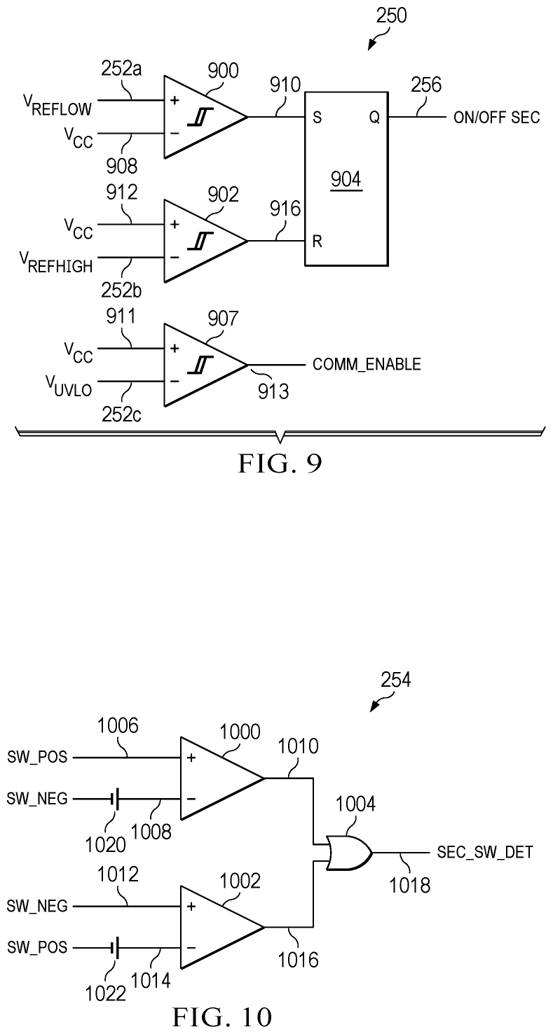

To generate ON/OFF-SEC, the voltage comparison circuit 250 compares V_{CC} to the V_{REF} reference voltages received on connections 252 and produces the signal ON/OFF-SEC on connection 256, which indicates when switching action of the switches 222 should be started and stopped to maintain V_{CC} within the hysteresis band defined by the V_{REF} reference voltages. FIG. 9 is a schematic diagram of an example voltage comparison circuit 250. The example voltage comparison circuit 250 includes a comparator 900, a comparator 902, and an SR flip flop 904. The comparator 900 includes inputs coupled to connections 252a and 908 and an output coupled to connection 910. The comparator 902 includes inputs coupled to connections 912 and 252b and an output coupled to connection 916. The flip flop 904 includes S and R inputs and a Q output coupled to a connection 256. The input coupled to connection 252a is a non-inverting input and receives V_{REFLOW}, which represents the lower boundary of the hysteresis band, and the input coupled to connection 252b is an inverting input and receives V_{REFHIGH}, which represents the upper boundary of the hysteresis band.

The inputs coupled to connections 908 and 912 both receive V_{CC} from the positive terminal 212 (FIG. 2). When V_{CC} drops just below V_{REFLOW}, the output 910 changes from low to high. At the same time, V_{CC} is lower than V_{REFHIGH}, so the output 916 remains low. Because the S input receives a high signal and the R input receives a low signal, the connection 256 (the ON/OFF-SEC signal) is latched high. As described below, ON/OFF-SEC becoming high causes the switches 222 to begin switching, which in turn causes V_{CC} to rise. As V_{CC} enters the hysteresis band, the outputs 910 and 916 are both low, but ON/OFF-SEC remains high because the connection 256 is latched high. When V_{CC} rises just above V_{REFHIGH}, the output 916 will be high, and the output 910 will be low. Consequently, the flip flop 904 will be reset, causing the connection 256 (the ON/OFF-SEC signal) to be latched low. This causes the switches 222 to cease switching, which in turn causes V_{CC} to fall. As V_{CC} re-enters the hysteresis band, the outputs 910 and 916 are both low, but ON/OFF-SEC remains low because the flip flop 904 is latched low.

In examples, the voltage comparison circuit 250 also includes a comparator 907 having an inverting input coupled to connection 252c and a non-inverting input coupled to connection 911, as well as an output coupled to connection 913. The connection 911 provides V_{CC}, the connection 252c provides V_{UVLO} (which is a threshold voltage, indicated by numeral 828 in FIG. 8, above which it may be safely assumed that the PCC 104 lacks short circuits), and the connection 913 receives COMM_ENABLE, which is signal 814 in FIG. 8. The COMM_ENABLE signal 814 goes high, as numeral 858 indicates, when V_{CC} rises above the threshold voltage V_{UVLO}, indicating that no short circuits are present and that the PING signals may be sent to the controller 220.

FIG. 10 is a schematic diagram of the transformer switching detection circuit 254, which generates SEC_SW_DET. The transformer switching detection circuit 254 includes a comparator 1000, a comparator 1002, and a logic OR gate 1004. The comparator 1000 includes a non-inverting input coupled to a connection 1006, an inverting input coupled to a connection 1008, and an output coupled to a connection 1010. The comparator 1002 includes a non-inverting input coupled to a connection 1012, an inverting input coupled to a connection 1014, and an output coupled to a connection 1016. The OR gate 1004 has inputs coupled to the connections 1010 and 1016 and has an output coupled to a connection 1018, which is coupled to the connection 258 of FIG. 2. A voltage bias 1020 is coupled to the connection 1008 and a voltage bias 1022 is coupled to the connection 1014. The connection 1006 is coupled to the terminal 264 and the connection 1008 is coupled to the terminal 266. The connection 1012 is coupled to the terminal 266 and the connection 1014 is coupled to the terminal 264. The comparator 1000 provides a high signal on the connection 1010 when the signal provided to connection 1006 is higher than the signal provided to connection 1008. Otherwise, the comparator 1000 provides a low signal on the connection 1010. Similarly, the comparator 1002 provides a high signal on the connection 1016 when the signal provided to connection 1012 is higher than the signal provided to connection 1014. The OR gate 1004 provides a high signal on the connection 1018 when the signals on connections 1010, 1016 both are high.

In operation, the transformer switching detection circuit 254 detects switching activity of the transformer 216 (and, more specifically, switching activity of the switches 222) by providing a first output when the transformer 216 is actively switching current direction due to the switching activity of the switches 222 and a second output when the transformer 216 is not actively switching current direction due to the switching activity of the switches 222. The voltage received on connection 1008 is biased by the voltage bias 1020, and the voltage received on connection 1014 is biased by the voltage bias 1022. When the current flowing between terminals 264, 266 (FIG. 2) is induced in one direction, the voltage SW_POS on connection 1006 will exceed the voltage of SW_NEG plus the voltage bias 1020 on connection 1008, thus causing connection 1010 to carry a high signal. Similarly, when the current flowing between terminals 264, 266 (FIG. 2) is induced in the opposite direction, the voltage SW_NEG on connection 1012 will exceed the voltage of SW_POS plus the voltage bias 1022 on connection 1014, thus causing connection 1016 to carry a high signal. In either case, the output of the OR gate 1004 will be a high on connection 1018 (SEC_SW_DET). In contrast, when the current between terminals 264, 266 is not switching direction due to the inactivity of the switches 222, the voltages SW_POS and SW_NEG will be approximately equal, and thus the outputs of connections 1010, 1016 will both be low, causing the output of the OR gate 1004 to be low on connection 1018. The high state of SEC_SW_DET on connection 1018 is thus interpreted to indicate switching activity of the switches 222 and transformer 216, and the low state of SEC_SW_DET on connection 1018 is interpreted to indicate a lack of switching activity of the switches 222 and transformer 216.

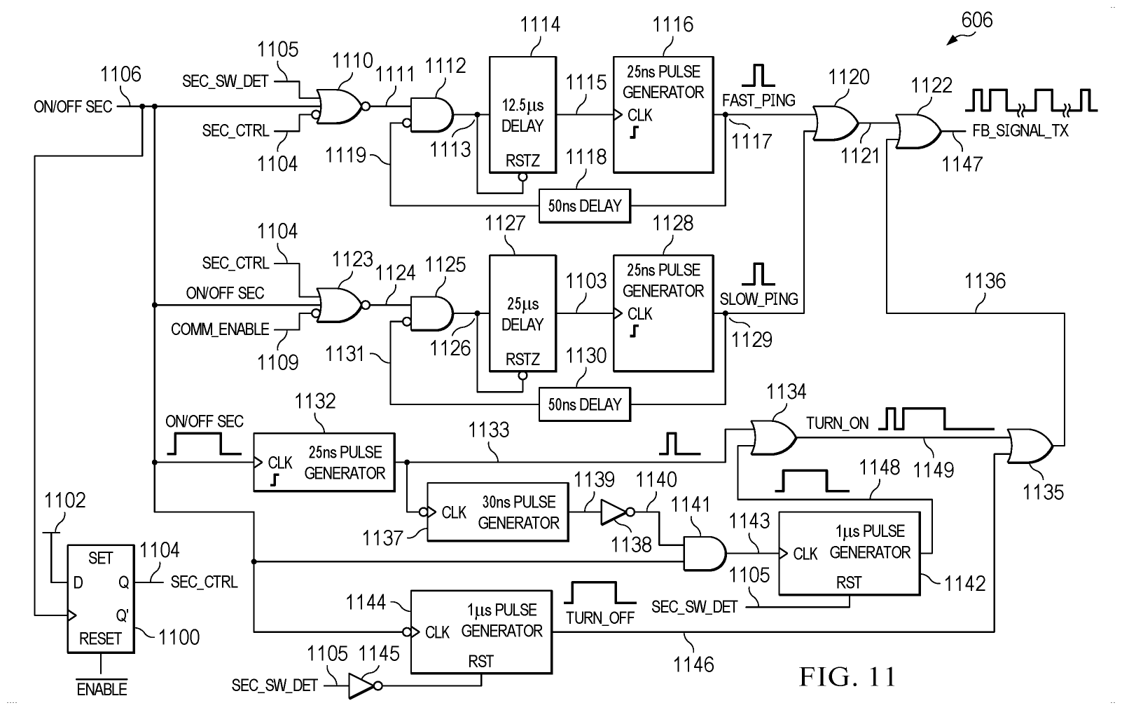

Referring again to FIGS. 2, 7, and 8 and now also to FIG. 11, the controller 244 receives ON/OFF-SEC, COMM_ENABLE, and SEC_SW_DET on connections 256, 257, and 258, respectively, as described, and the controller 244 uses these signals to generate the PING signals. For example, the encoding circuit 606 within the controller 244 (FIG. 6) may use the ON/OFF-SEC, COMM_ENABLE, and SEC_SW_DET signals to generate the PING signals. FIG. 11 is a schematic diagram of the encoding circuit 606. The encoding circuit 606 may include a D flip flop 1100. The D flip flop 1100, in turn, may include a D input, a clock input, a RESET input, and a Q output. The D input may be coupled to a voltage source 1102. The clock input may be coupled to a connection 1106, which couples to connection 256 and through which the ON/OFF-SEC signal is received. The Q output is coupled to a connection 1104 on which the D flip flop 1100 provides a signal SEC_CTRL. The signal SEC_CTRL indicates whether the PCC 104 is to be in regulation mode (as indicated by numeral 808 in the timing diagram 800 of FIG. 8). The RESET input receives an inverse of the ENABLE signal, described above.

The encoding circuit 606 may include a logic NOR gate 1110 having multiple inputs. A first input to the NOR gate 1110 may be coupled to a connection 1105, which couples to connection 258 (FIG. 2) and provides the signal SEC_SW_DET. A second input to the NOR gate 1110 may be coupled to the connection 1106, which provides ON/OFF-SEC. A third input to the NOR gate 1110 may be coupled to the connection 1104, which provides the signal SEC_CTRL. The third input may be an inverting input. The NOR gate 1110 has an output coupled to a connection 1111.

The encoding circuit 606 includes a logic AND gate 1112 with a first input coupled to connection 1111 and a second, inverting input coupled to a connection 1119. The AND gate 1112 has an output coupled to a connection 1113. The encoding circuit 606 includes a delay block 1114, such as a 12.5 microsecond delay block, which has an input coupled to the connection 1113 and an inverting reset input coupled to the connection 1113. The delay block 1114 has an output coupled to a connection 1115.

The encoding circuit 606 includes a pulse generator 1116, such as a 25 nanosecond (ns) pulse generator, having a clock input that is coupled to the connection 1115, and an output coupled to a connection 1117. A feedback delay block 1118 has an input that is coupled to the connection 1117 and an output that is coupled to the connection 1119.

The encoding circuit 606 includes a logic OR gate 1120 that includes a first input coupled to the connection 1117 and a second input coupled to a connection 1129. The OR gate 1120 provides an output coupled to a connection 1121.

The encoding circuit 606 includes a NOR gate 1123 having a first input coupled to the connection 1104 on which SEC_CTRL is received, a second input that is coupled to the connection 1106 on which ON/OFF-SEC is received, and a third, inverting input that is coupled to connection 1109 on which COMM_ENABLE is received. The NOR gate 1123 includes an output coupled to a connection 1124. The encoding circuit 606 includes a logic AND gate 1125 having a first input coupled to the connection 1124 and a second, inverting input coupled to a connection 1131. The AND gate 1125 has an output coupled to a connection 1126.

The encoding circuit 606 includes a delay block 1127, such as a 25 microsecond delay block, which has an input coupled to the connection 1126, an inverting reset input coupled to the connection 1126, and an output coupled to a connection 1103. The encoding circuit 606 includes a pulse generator 1128, such as a 25 ns pulse generator, having a clock input coupled to the connection 1103 and an output coupled to the connection 1129. The encoding circuit 606 may include a delay block 1130, such as a 50 ns delay block, having an input coupled to the connection 1129 and an output coupled to the connection 1131.

The encoding circuit 606 may include a pulse generator 1132, such as a 25 ns pulse generator, having a clock input coupled to the connection 1106 to receive ON/OFF-SEC and an output coupled to a connection 1133. The encoding circuit 606 includes a pulse generator 1137, such as a 30 ns pulse generator, having a clock input coupled to the connection 1133 and an output coupled to a connection 1139. The encoding circuit 606 includes an inverter 1138 having an input coupled to the connection 1139 and an output coupled to a connection 1140. A logic AND gate has a first input coupled to the connection 1140 and a second input coupled to the connection 1106, as well as an output coupled to a connection 1143. A pulse generator 1142, such as a 1 microsecond pulse generator, has a clock input coupled to the connection 1143, a reset input coupled to the connection 1105 (e.g., to receive SEC_SW_DET), and an output coupled to a connection 1148. The encoding circuit 606 also includes a pulse generator 1144, such as a 1 microsecond pulse generator, having a clock input coupled to the connection 1106 (e.g., to receive ON/OFF-SEC), a reset input coupled to an output of an inverter 1145, and an output coupled to a connection 1146. The input to the inverter 1145 is coupled to the connection 1105 (e.g., to receive SEC_SW_DET).

The encoding circuit 606 may include a logic OR gate 1134 having a first input coupled to the connection 1133, a second input coupled to the connection 1148, and an output coupled to a connection 1149. A logic OR gate has a first input coupled to the connection 1149, a second input coupled to the connection 1146, and an output coupled to a connection 1136. A logic OR gate 1122 includes a first input coupled to the connection 1121, a second input coupled to the connection 1136, and an output coupled to a connection 1147.

The operation of the encoding circuit 606, and thus the generation of the PING signals, is now described. The encoding circuit 606 uses signal ON/OFF-SEC, SEC_SW_DET, COMM_ENABLE, and SEC_CTRL to produce the PING signals. While ON/OFF-SEC, SEC_SW_DET, and COMM_ENABLE are already available to the encoding circuit 606 as provided by other components in the PCC 104, the encoding circuit 606 should produce SEC_CTRL. Accordingly, referring to FIGS. 8 and 11, the D flip-flop 1100 uses ON/OFF-SEC to produce the signal SEC_CTRL, which indicates that the PCC 104 is in hysteresis operation (e.g., regulation mode 808). The D flip-flop 1100 is triggered upon receipt of a rising edge of ON/OFF-SEC. Because ON/OFF-SEC only includes pulses during regulation mode 808, the presence of a rising edge of ON/OFF-SEC indicates that regulation mode 808 has begun. The receipt of the rising edge triggers the D flip-flop 1100 to capture the high signal at the D input, which is provided by voltage source 1102. The Q output provides the latched high signal on connection 1104 as SEC_CTRL. After SEC_CTRL goes high, SEC_CTRL should remain high until the PCC 104 is turned off and turned on again, at which point SEC_CTRL should go low until the controller 220 has an opportunity to assess the PING signals received from the controller 244. Accordingly, an inverse of the ENABLE signal 812 is provided to the RESET input of the D flip-flop 1100.

The components 1110, 1112, 1114, 1116, and 1118 together use SEC_SW_DET, ON/OFF-SEC, and SEC_CTRL to produce high-frequency PING signals that would cause the controller 220 to enable the regulation mode 808, as described above. Such high-frequency PING signals may be referred to herein as fast PING signals. The components 1123, 1125, 1127, 1128, and 1130 together use SEC_CTRL, COMM_ENABLE, and ON/OFF-SEC to produce low-frequency PING signals that would cause the controller 220 to enable the uncapped duty cycle mode 806, as described above. Such low-frequency PING signals (which are greater than zero frequency but less than the frequency threshold to qualify as a fast PING signal) may be referred to herein as slow PING signals. Zero-frequency PING signals are simply the absence of fast and slow PING signals.

The pulse generator 1116 generates each pulse of the fast PING signal. Similarly, the pulse generator 1128 generates each pulse of the slow PING signal. The delays between consecutive pulses of a fast PING signal are provided by the delay block 1114. Likewise, the delays between consecutive pulses of a slow PING signal are provided by the delay block 1127. Because the slow PING signal has a lower frequency than the fast PING signal, the delay provided by the delay block 1127 (e.g., 25 microseconds) may be greater than the delay provided by the delay block 1114 (e.g., 12.5 microseconds). The AND gates 1112 and 1125 determine whether a fast or slow PING signal is generated at a given time. For a fast PING signal to be generated, the output of the AND gate 1112 on connection 1113 must be high, and likewise, for a slow PING signal to be generated, the output of the AND gate 1125 on connection 1126 must be high. Because fast and slow PING signals cannot be sent simultaneously, no more than one of the connections 1113, 1126 will be high at a given time. In the case of a zero frequency PING signal, neither of the connections 1113, 1126 will be high.

Whether the output of the AND gate 1112 is high depends on whether both of the AND gate 1112 inputs are satisfied. The second input of the AND gate 1112 is an inverting input, so to be satisfied, the connection 1119 should be low. For the first input of the AND gate 1112 to be satisfied, the connection 1111 should be high. For connection 1111 to be high, none of the inputs to be NOR gate 1110 can be satisfied. Stated differently, the SEC_SW_DET signal must be low (i.e., the switches 222 must not be actively switching), the SEC_CTRL signal must be high (i.e., the PCC 104 must be in regulation mode 808), and the ON/OFF-SEC signal must be low (i.e., V_{CC} must be within the boundaries of the target hysteresis band). If none of the inputs to the NOR gate 1110 is satisfied, the connection 1111 will carry a high signal, and when connection 1119 is low in between pulses generated by the pulse generator 1116, the AND gate 1112 will provide a high signal on connection 1113. The change from low to high on the connection 1113 will cause the delay block 1114 to stop resetting and to begin counting to 12.5 microseconds, after which the high signal on 1113 will be provided to connection 1115 and to the clock input on the pulse generator 1116. The rising edge provided to the clock input on the pulse generator 1116 triggers the generation of a 25 ns pulse. The pulse is delayed by a short amount of time (e.g., 50 ns) by the delay block 1118 and is then provided to the connection 1119, at which point the process repeats. In this manner, based on the status of V_{CC} with respect to the target hysteresis band (e.g., ON/OFF-SEC and SEC_CTRL) as well as the switching status of the switches 222 (e.g., SEC_SW_DET), the encoding circuit 606 produces a fast PING signal. The delay block 1118 ensures the pulse generator 1116 is not reset too soon. In the absence of the delay block 1118, as soon as the fast PING signal goes high, the fast PING signal will reset connection 1113 to low, and connection 1115 will also go low. Stated differently, the delay block 1118 supports the setup and hold time requirements for the clock logic of the pulse generator 1116.

The generation of a slow PING signal by components 1125, 1127, 1128, and 1130 is identical to the generation of the fast PING signal, except for the increased delay provided by delay block 1127 relative to the delay provided by delay block 1114. The inputs to the NOR gate 1123 also differ compared to the input to the NOR gate 1110. The NOR gate 1123 receives SEC_CTRL, COMM_ENABLE, and ON/OFF-SEC. When SEC_CTRL is low, meaning that the PCC 104 is not in regulation mode 808, and further when COMM_ENABLE is high, meaning that V_{CC} exceeds the voltage threshold V_{UVLO}, and further when ON/OFF-SEC is low, meaning that V_{CC} is within the boundaries of the target hysteresis band, the NOR gate 1123 provides a high signal on 1124. Because the remainder of the generation of the slow PING signal is virtually identical to the generation of the fast PING signal, the specific operation of components 1125, 1127, 1128, and 1130 is not provided again here.

The OR gate 1120 combines the fast and slow PING signals to produce a single PING signal on connection 1121. Because the fast and slow PING signals do not occur simultaneously, the PING signal on connection 1121 includes pulses of the same width but of varying frequency, depending on whether fast or slow PING pulses are being generated.

The timing diagram 800 depicts the PING signals 818 generated by the encoding circuit 606. When the PCC 104 should be in the regulation mode 808 (e.g., because V_{CC} has reached the hysteresis band), the controller 244 (e.g., the encoding circuit 606) generates the fast PING signal, as indicated by numeral 876. As shown in the timing diagram 800 and as described above with reference to the encoding circuit 606, the fast PING pulses 876 are generated only when ON/OFF-SEC is low (i.e., in between ON/OFF-SEC pulses 860, 862, 864, and 866), when the PCC 104 is in regulation mode 808 (i.e., SEC_CTRL is high), and when switching action of the switches 222 is off (i.e., not coinciding with ON/OFF-PRIM pulses 890, 892, and 894). When the PCC 104 should be operating in the uncapped duty cycle mode 806 (e.g., because V_{CC} is greater than a voltage threshold 828 but not yet in the hysteresis band), the controller 244 generates the slow PING signal pulses 874. A PING signal frequency of zero corresponds to the capped duty cycle mode 804, as shown.

In addition to generating the PING signals, the encoding circuit 606 also generates pulses that signal to the controller 220 when the switching action of the switches 222 should be turned on (referred to herein as “turn on pulses”), and pulses that signal to the controller 220 when the switching action of the switches 222 should be turned off (referred to herein as “turn off pulses”). In FIG. 11, components 1132, 1137, 1138, 1141, 1142, and 1134 generate the turn on pulses, and components 1144 and 1145 generate the turn off pulses. The turn on pulses are a pair of pulses, the first pulse having a shorter pulse width, and the second pulse having a longer pulse width. The first and second pulses are separated by a defined delay. When the controller 220 receives a pair of pulses having this particular pattern, the controller 220 recognizes the pulses as an instruction to begin switching action of the switches 222 (e.g., because V_{CC} is dropping too low relative to the lower boundary of the target hysteresis band). A turn off pulse is a single pulse of a predetermined pulse width, and when received after the pair of turn on pulses, the controller 220 recognizes the turn off pulse as an instruction to cease switching action of the switches 222 (e.g., because V_{CC} is rising too high relative to the upper boundary of the target hysteresis band). The components of the encoding circuit 606 that generate the turn on pulses are triggered to generate a pair of turn on pulses when a rising edge of ON/OFF-SEC is received, and the components of the encoding circuit 606 that generate the turn off pulses are triggered to generate a turn off pulse when a falling edge of ON/OFF-SEC is received.

In particular, the rising edge of an ON/OFF-SEC pulse triggers the clock input to the pulse generator 1132 (e.g., a 25 ns pulse generator), causing the pulse generator 1132 to provide a pulse with a relatively short pulse width (e.g., 25 ns) on connection 1133. The pulse is also provided to the inverting clock input of the pulse generator 1137 (e.g., a 30 ns pulse generator). The clock input of the pulse generator 1137 receives the pulse, and as the falling edge of the pulse is received, the pulse generator 1137 produces a pulse on the connection 1139. That pulse on connection 1139 is inverted by the inverter 1138, producing an inverse pulse on connection 1140. This inverse pulse is received by the AND gate 1141, and because the inverse pulse is low, the output of the AND gate on connection 1143 will remain low for the duration of the inverse pulse. In this way, the inverse pulse creates a delay, or gap, between the shorter pulse and longer pulse of the pair of turn on pulses described above and shown by numerals 884 in the timing diagram 800. As the inverse pulse on connection 1140 passes and both inputs to the AND gate 1141 become high, the connection 1143 provides a rising edge to the clock input of the pulse generator 1142 (e.g., a 1 microsecond pulse generator), which triggers the pulse generator 1142 to produce a pulse that has a relatively wide pulse width relative to the pulse generated by the pulse generator 1132. The pulse generator 1142 is reset when SEC_SW_DET on connection 1105 becomes high.

When ON/OFF-SEC has a falling edge, the clock input to pulse generator 1144 (e.g., a 1 microsecond pulse generator) is triggered, causing the pulse generator 1144 to produce a turn off pulse on connection 1146, as described above. The pulse generator 1144 is reset by an inverse of SEC_SW_DET produced by the inverter 1145.

The OR gate 1135 combines the turn on and turn off pulses on connections 1149 and 1146 and provides the resulting signal on connection 1136, and OR gate 1122 combines the PING signals and turn on and turn off pulses received on connections 1121 and 1136 to produce FB_SIGNAL_TX on connection 1147, which may be coupled to the connection 260 (FIG. 2).

The controller 244 provides FB_SIGNAL_TX on the connection 260 (FIG. 2). The modulator 246 receives FB_SIGNAL_TX and modulates the alternating current flowing through the winding 268 based on FB_SIGNAL_TX. The alternating current in the winding 268 generates an electromagnetic field, which induces a current in the winding 232. The current in winding 232 contains the information provided by FB_SIGNAL_TX. The demodulator 225 demodulates the current flowing through the winding 232 to produce FB_SIGNAL_RX, which is identical or virtually identical to FB_SIGNAL_TX. The demodulator 225 provides FB_SIGNAL_RX to the controller 220 by way of the connection 226.

The circuitry shown in FIG. 11 may not necessarily represent all circuitry included in the controller 244. Other operations attributed herein to the controller 244 may be performed by other circuitry and logic, such as the processor 600 and memory 602 shown in FIG. 6. Some or all of the actions attributed herein to the encoding circuit 606 may be performed by the processor 600 by executing the executable instructions 604 (FIG. 6).

As shown in FIG. 4, the controller 220 may include a decoding circuit 406 to decode FB_SIGNAL_RX. In some examples, the processor 400 by executing the executable instructions 404 may perform some or all of the actions attributed herein to the controller 220 and/or to the decoding circuit 406.

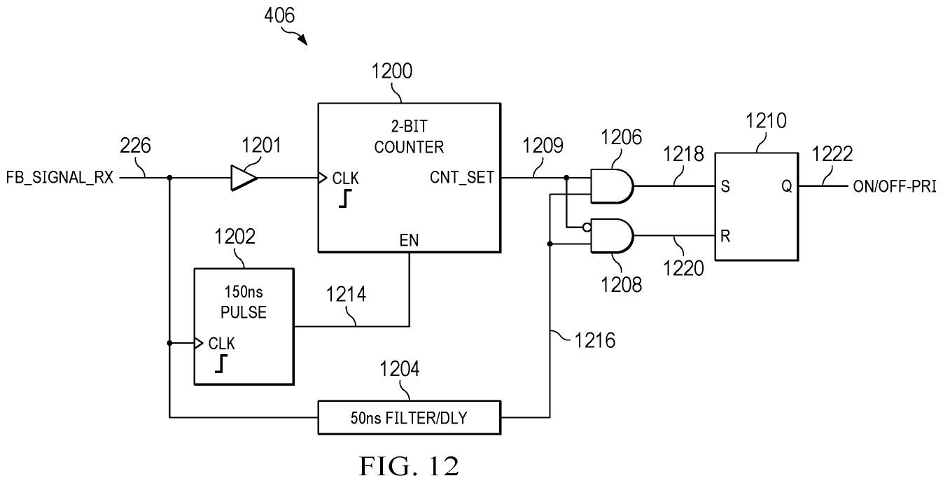

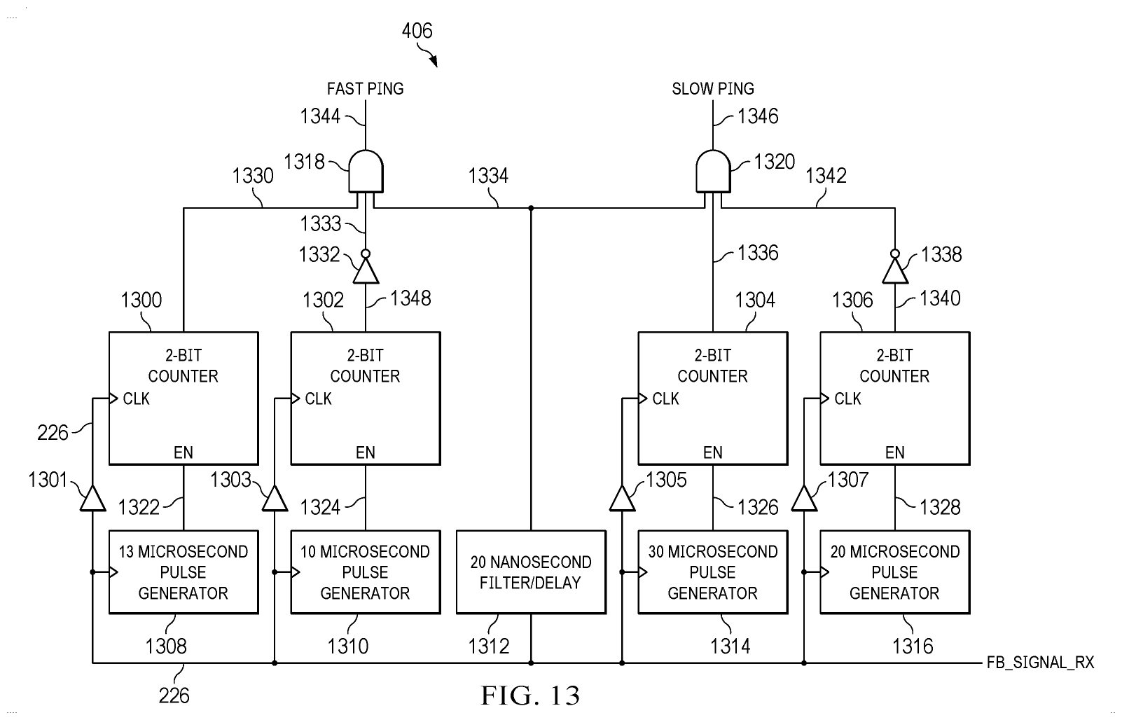

The decoding circuit 406 is configured to separate FB_SIGNAL_RX into its constituent components, e.g., the PING signals and the turn on and turn off pulses. FIGS. 12 and 13 include example portions of the decoding circuit 406. The circuitry shown in FIG. 12 is configured to isolate the turn on and turn off pulses and to generate ON/OFF-PRIM based on those turn on and turn off pulses. The circuitry shown in FIG. 13 is configured to isolate the PING signals and to use the PING signals to determine which operating mode of the PCC 104 should be enabled and how the switches 222 are to be operated.

In FIG. 12, the decoding circuit 406 includes a 2-bit counter 1200 having a clock input coupled to connection 226 by way of a delay block 1201, an ENABLE input coupled to a connection 1214, and an output coupled to a connection 1209. The circuit 406 also includes a pulse generator 1202 (e.g., a 150 ns pulse generator) having a clock input coupled to the connection 226 and an output coupled to the connection 1214. The circuit 406 further includes a filter/delay block 1204 (e.g., a 50 ns filter/delay block, such as a resistive-capacitive (RC) delay), which has an input that is coupled to the connection 226 and an output that is coupled to a connection 1216. Further, the decoding circuit 406 includes a logic AND gate 1206 having a first input coupled to the connection 1209 and a second input coupled to the connection 1216. The decoding circuit 406 also comprises an AND gate 1208 having an inverting input coupled to the connection 1209 and another input coupled to the connection 1216. An output of the AND gate 1206 is coupled to a connection 1218, and an output of the AND gate 1208 is coupled to a connection 1220. The decoding circuit 406 includes an SR flip-flop 1210 having an S input coupled to the connection 1218, an R input coupled to the connection 1220, and a Q output coupled to a connection 1222. When FB_SIGNAL_RX goes from low to high on connection 226 (a rising edge), the clock input of the pulse generator 1202 is triggered. As a result, the pulse generator 1202 provides a pulse of defined width (e.g., 150 ns) on connection 1214, which enables the 2-bit counter 1200 for 150 ns. During this time that the 2-bit counter 1200 is enabled, the 2-bit counter 1200 monitors its clock input for two rising edges. The first of the two rising edges is the rising edge that triggered the pulse generator 1202, and the delay block 1201 enables the 2-bit counter 1200 to count this rising edge after the 2-bit counter 1200 has been enabled. The receipt of two rising edges (e.g., from two separate pulses) within 150 ns indicates that the received pulses are likely a pair of turn on pulses as described above, and when the output of the filter/delay block 1204 (the function of which is to filter out pulses with duration less than a threshold duration, such as 50 ns) on connection 1216 is high, the likelihood that the pulses are PING signal pulses (which are significantly smaller in width than the turn on and turn off pulses) is eliminated. Accordingly, both inputs to the AND gate 1206 are high, and thus the output of the AND gate 1206 on connection 1218 is high, while the output of the AND gate 1208 on connection 1220 is low. Because the SR flip-flop 1210 receives a high S input and a low R input, the SR flip-flop 1210 latches high and provides a Q output on connection 1222 that is high. Conversely, when a single turn off pulse is received, the output of the 2-bit counter 1200 will be low, but the output of the filter/delay block 1204 on connection 1216 will be high, thus causing the connection 1218 to go low and the connection 1220 to go high. Consequently, the SR flip-flop 1210 is reset, causing the Q output to provide a low signal on connection 1222. In this way, the circuitry in FIG. 12 produces ON/OFF-PRIM on connection 1222, which goes high when a pair of turn on pulses are received and which goes low when a turn off pulse is received. The timing diagram 800 shows this behavior. The ON/OFF-PRIM signal 822 includes pulses 890, 892, and 894. The pulse 890 goes high upon completion of the receipt of the pair of turn on pulses 884 in FB_SIGNAL_RX. Conversely, the pulse 890 goes low upon completion of the receipt of the turn off pulse 886 in FB_SIGNAL_RX. The pulses 892 and 894 exhibit the same behavior as pulse 890.

As mentioned, FIG. 13 depicts another example portion of the decoding circuit 406 that is configured to determine the frequency of the PING signals included in FB_SIGNAL_RX. The example circuitry of the decoding circuit 406 includes the connection 226 on which FB_SIGNAL_RX is received, a 2-bit counter 1300 having a clock input coupled to the connection 226 by way of a delay block 1301 and an ENABLE input coupled to a connection 1322, and an output coupled to a connection 1330. The connection 1330 is coupled to an input of a logic AND gate 1318. The circuitry includes a 13 microsecond pulse generator 1308 having a clock input coupled to the connection 226 and an output coupled to the connection 1322. The circuitry includes a 2-bit counter 1302 with a clock input coupled to the connection 226 by way of a delay block 1303 and an ENABLE input coupled to a connection 1324, with an output coupled to a connection 1348. The circuitry also includes a 10 microsecond pulse generator 1310 having a clock input coupled to the connection 226 and an output coupled to the connection 1324. An inverter 1332 has an input coupled to the connection 1348 and an output coupled to a connection 1333, which is coupled to an input of the logic AND gate 1318. The circuitry includes a 20 nanosecond filter/delay block 1312 (e.g., a pulse width filter) having an input coupled to the connection 226 and an output coupled to a connection 1334, which is coupled to an input of the AND gate 1318. The circuitry also includes a 2-bit counter 1304 having a clock input coupled to the connection 226 by way of a delay block 1305 and an ENABLE input coupled to a connection 1326, along with an output coupled to a connection 1336. The connections 1334 and 1336 are coupled to inputs of a logic AND gate 1320. A 30 microsecond pulse generator 1314 has a clock input coupled to the connection 226 and an output coupled to the connection 1326. The circuitry further comprises a 2-bit clock counter 1306 having a clock input coupled to the connection 226 by way of a delay block 1307 and an ENABLE input coupled to a connection 1328, as well as an output coupled to a connection 1340. The circuitry also includes a 20 microsecond pulse generator 1316 having a clock input coupled to the connection 226 and an output coupled to the connection 1328. An inverter 1338 includes an input coupled to the connection 1340 and an output coupled to a connection 1342, which is coupled to an input of the AND gate 1320. The AND gate 1318 has an output coupled to a connection 1344, and the AND gate 1320 has an output coupled to a connection 1346.

The connection 226 provides FB_SIGNAL_RX. With reference to FB_SIGNAL_RX signal 820 in FIG. 8 and the circuitry of FIG. 13, the rising edge of each pulse in FB_SIGNAL_RX triggers the pulse generator 1308, which generates a 13 microsecond pulse on connection 1322. Thus, the 2-bit counter 1300 is enabled for 13 microseconds beginning at the rising edge of each pulse in FB_SIGNAL_RX. During the time that the 2-bit counter 1300 is enabled, if two rising edges are received at the clock input of the 2-bit counter 1300, the 2-bit counter 1300 provides a high signal on the connection 1330. The delay block 1301 enables the 2-bit counter 1300 to count the rising edge that triggered the pulse generator 1308. Thus, the pulse generator 1308 and the 2-bit counter 1300 operate together to determine whether two consecutive pulses occur within 13 microseconds of each other. If such pulses are received in FB_SIGNAL_RX, those pulses may be fast PING pulses. The rising edge of each pulse in FB_SIGNAL_RX also triggers the generation of a 10 microsecond pulse on connection 1324. Thus, the 2-bit counter 1302 is enabled for 10 microseconds. If, during those 10 microseconds, the 2-bit counter 1302 receives two rising edges at the clock input, the 2-bit counter 1302 generates a high signal on connection 1348, which is inverted by inverter 1332 to produce a low signal on connection 1333, and vice versa. Thus, the pulse generator 1310, the 2-bit counter 1302, and the inverter 1332 operate together to determine whether two consecutive pulses are separated by at least 10 microseconds, and if so, the inverter 1332 provides a high signal on connection 1333. The delay block 1303 enables the 2-bit counter 1302 to count the rising edge that triggered the pulse generator 1310. If such pulses are received in FB_SIGNAL_RX, those pulses may be fast PING pulses. The 20 nanosecond filter/delay block 1312 receives FB_SIGNAL_RX and provides on connection 1334 only those signals having a pulse width of at least 20 nanoseconds, meaning that the filter/delay block 1312 filters out possible noise in FB_SIGNAL_RX. If the connections 1330, 1333, and 1334 each carry a high signal, the AND gate 1318 provides a high signal on connection 1344, signifying that a pair of pulses at least 20 nanoseconds in width each and separated by at least 10 microseconds but no more than 13 microseconds is present in FB_SIGNAL_RX. Such a pair of pulses would accurately be characterized as fast PING pulses, and thus a high signal on connection 1344 indicates to the controller 220 (e.g., to the processor 400 (FIG. 4)) that the controller 244 is instructing the controller 220 to enable an operation mode for the PCC 104 that corresponds to fast PING signals.

The rising edge of a pulse in FB_SIGNAL_RX received by the 30 microsecond pulse generator 1314 generates a high signal on connection 1326 that enables the 2-bit counter 1304 for 30 microseconds. If, during those 30 microseconds, at least two rising edges are received at the clock input of the 2-bit counter 1304, the 2-bit counter 1304 provides a high signal on connection 1336. The delay block 1305 enables the 2-bit counter 1304 to count the rising edge that triggered the pulse generator 1314. Similarly, the rising edge of a pulse in FB_SIGNAL_RX received by the 20 microsecond pulse generator 1316 generates a high signal on connection 1328 that enables the 2-bit counter 1306 for 20 microseconds. If, during those 20 microseconds, at least two rising edges are received at the clock input of the 2-bit counter 1306, the 2-bit counter 1306 provides a high signal on connection 1340, which the inverter 1338 inverts to produce a high signal on connection 1342, and vice versa. The delay block 1307 enables the 2-bit counter 1306 to count the rising edge that triggered the pulse generator 1316. Thus, the pulse generator 1316, the 2-bit counter 1306, and the inverter 1338 together operate to identify pairs of pulses that are not received within 20 microseconds of each other, while the pulse generator 1314 and the 2-bit counter 1304 together operate to identify pairs of pulses that are received within 30 microseconds of each other. When the connections 1334, 1336, and 1342 all provide high signals to the AND gate 1320, the AND gate 1320 provides a high signal to the connection 1346. Stated differently, the components 1304, 1314, 1316, 1306, 1338, 1312 and 1320 together operate to identify slow PING pulses, which are at least 20 nanoseconds in width, with consecutives pulses being spaced between 20 microseconds and 30 microseconds apart. A high signal on connection 1346 indicates to the controller 220 (e.g., to the processor 400 (FIG. 4)) that the controller 244 is instructing the controller 220 to enable an operation mode for the PCC 104 that corresponds to slow PING signals. A low signal on both connections 1344 and 1346 indicates a no PING signal on FB_SIGNAL_RX, and the controller 220 is configured to enable an operation mode for the PCC 104 that corresponds to no PING signals.

The specific parameters of the various components shown in FIG. 13 are selected based on the properties of the pulses included in FB_SIGNAL_RX. The parameters of the components shown in FIG. 13 may be varied to accommodate different frequencies and pulse widths of pulses in FB_SIGNAL_RX.

Referring again to FIGS. 2, 7, and 8, as described above, the method 700 comprises the controller 220 detecting the PING signal received in FB_SIGNAL_RX during monitor mode 802, for example, immediately upon the PCC 104 being enabled by the ENABLE signal 812 (e.g., by rising edge 856 of the ENABLE signal 812). If the portion of the decoding circuit 406 shown in FIG. 13 indicates that FB_SIGNAL_RX includes no PING signal, the controller 220 takes branch 706 of the method 700 to enable the capped duty cycle mode 804. During the capped duty cycle mode 804, the controller 220 gradually increases the duty cycle used to switch the switches 222 (712). More specifically, when the PING signal 818 has a zero frequency as in capped duty cycle mode 804, the controller 220 gradually increases the duty cycle of the ON/OFF-PRIM signal 822, as indicated by the duty cycle changes reflected in signal 824. As the duty cycle is increased, V_{CC} 810 begins to rise and continues to rise. However, the duty cycle is capped while the PCC 104 is operating in the capped duty cycle mode 804 (e.g., the controller 220 may be preprogrammed not to exceed a specific duty cycle when in the capped duty cycle mode 804).

If the decoding circuit 406 shown in FIG. 13 indicates that FB_SIGNAL_RX includes a slow PING signal (numeral 878 in FIG. 8), the controller 220 takes branch 708 of the method 700 to enter the uncapped duty cycle mode 806. More specifically, when the PING signal 818 is a slow PING signal as numeral 874 indicates in uncapped duty cycle mode 806, the controller 220 gradually increases the duty cycle used to switch the switches 222, but there is no cap on how high the duty cycle may rise (716). Notably, the controller 220 may directly enter the uncapped duty cycle mode 806 upon detecting a slow PING signal in FB_SIGNAL_RX, without first having to enter the capped duty cycle mode 804 or any other operation mode. During uncapped duty cycle mode 806, the duty cycle of ON/OFF-PRIM continues to rise, as signal 822 indicates, and also during mode 806, the V_{CC} continues to rise, as V_{CC} signal 810 indicates.

If the decoding circuit 406 shown in FIG. 13 indicates that FB_SIGNAL_RX includes a fast PING signal, the controller 220 takes branch 710 and enables a regulation mode with hysteretic control (720), which is depicted in timing diagram 800 as regulation mode 808. During regulation mode 808, the controller 220 operates the switching action of the switches 222 (e.g., by controlling ON/OFF-PRIM) to keep V_{CC} nearly within the hysteresis band denoted by numerals 830 and 832. When V_{CC} signal 810 reaches the lower boundary 832 of the hysteresis band, ON/OFF-SEC rises (e.g., pulses 860, 862, 864, 866), which causes a pair of turn on pulses (e.g., numeral 884) to be provided by the controller 244 to the controller 220 alongside fast PING signals (e.g., numerals 882, 888), as FB_SIGNAL_TX and FB_SIGNAL_RX 820 indicate. Upon receiving and decoding FB_SIGNAL_RX, the controller 220 provides a rising edge of a pulse (e.g., pulse 890, 892, 894) in ON/OFF-PRIM signal 822, causing switching action of the switches 222 to begin. When V_{CC} signal 810 reaches the upper boundary 830 of the hysteresis band, ON/OFF-SEC falls, which causes a turn off pulse (e.g., numeral 886) to be provided by the controller 244 to the controller 220 alongside fast PING signals, as FB_SIGNAL_TX and FB_SIGNAL_RX 820 indicate. Upon receiving and decoding FB_SIGNAL_RX, the controller 220 provides a falling edge of a pulse in ON/OFF-PRIM signal 822, causing the switching action of the switches 222 to stop. Notably, the controller 220 is configured to directly enter the regulation mode 808 upon detecting a fast PING signal, and without having to enter modes 804 and/or 806 prior to entering mode 808. Also, because there is a delay between the time VCC crosses a hysteresis band 830, 832 and the time that the primary side switches are controlled to start or stop switching, VCC will extend slightly beyond the bands 830, 832, as shown.

Although the controller 220 may enable any operating mode of the PCC 104 without first having to enable another operating mode of the PCC 104, in examples, the controller 220 may progress from one operating mode to another. For example, when operating in the capped duty cycle mode 804 (712), the controller 220 may monitor FB_SIGNAL_RX for a slow PING signal (714). Responsive to the receipt of such a slow PING signal, the controller 220 may enable the uncapped duty cycle mode 806 (716). Similarly, when operating in the uncapped duty cycle mode 806 (716), the controller 220 may monitor FB_SIGNAL_RX for a fast PING signal (718), which may be identified by as described in detail above, or alternatively by a pulse (referred to herein as a “flag pulse”) of predetermined length (generated by, e.g., the controller 244) that instructs the controller 220 to enable the regulation mode 808. Responsive to the receipt of a fast PING signal, the controller 220 may enable the regulation mode 808 (720).

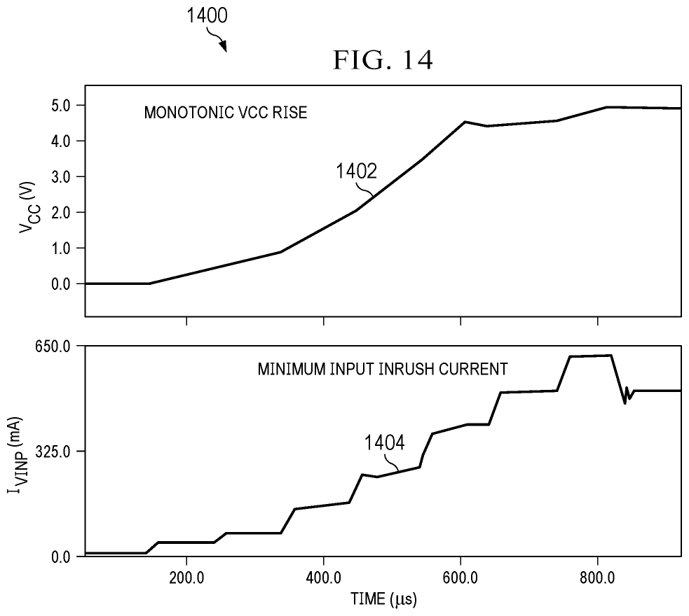

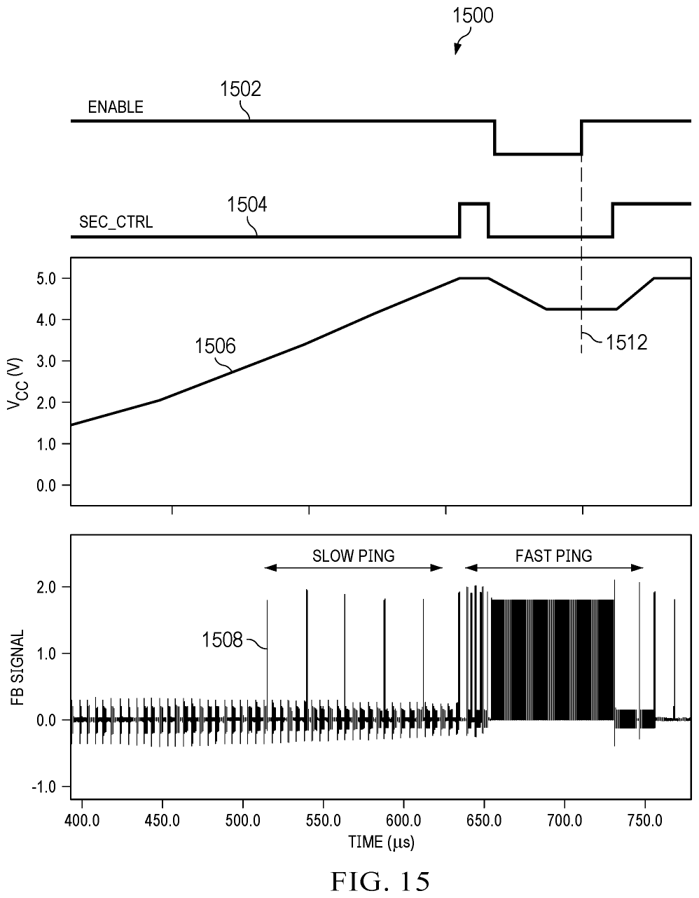

FIGS. 14 and 15 are graphs indicating the operation of a low inrush current power converter circuit, in accordance with various examples. Specifically, FIG. 14 shows a pair of graphs 1400 with time on the x-axis and magnitude (voltage in volts for the upper graph; current in milliamps for the lower graph) on the y-axis. As curve 1402 shows, V_{CC} rises smoothly from the time at which the PCC 104 is enabled up to the time when regulation mode 808 is reached, and also after regulation mode 808 is reached. Similarly, as curve 1404 shows, the inrush current to PCC 104 rises smoothly, without large spikes that result in the various technical challenges described above. FIGS. 14 and 15 assume that the capacitor 210 (FIG. 2) is fully or nearly fully discharged prior to enabling the PCC 104.

FIG. 15 shows a pair of graphs 1500 depicting curves 1502, 1504, 1506, and 1508. Curve 1502 is the ENABLE signal, curve 1504 is the SEC_CTRL signal, curve 1506 is V_{CC}, and curve 1508 is FB_SIGNAL_RX. FIG. 15 differs from FIG. 14 in that the PCC 104 is operating, then is disabled, and then is enabled again, with the second enablement occurring before the capacitor 210 (FIG. 2) has discharged. Thus, as shown, ENABLE signal 1502 is high while SEC_CTRL signal 1504 is low, and no PING signals are being received on FB_SIGNAL_RX 1508, meaning the PCC 104 is in the capped duty cycle mode 804. The V_{CC} signal 1506 continues to rise smoothly as a slow PING signal is received on FB_SIGNAL_RX 1508, causing the controller 220 to enable the uncapped duty cycle mode 806 for the PCC 104. The V_{CC} signal 1506 plateaus upon reaching the regulation mode 808, during which FB_SIGNAL_RX 1508 provides fast PING signals. The SEC_CTRL signal 1504 also goes high to indicate regulation mode 808 has begun. At this point, the ENABLE signal 1502 goes low, meaning power to the PCC 104 is disconnected, and the V_{CC} signal 1506 begins to fall. At time 1512, the ENABLE signal 1502 goes high again, meaning that power is again supplied to the PCC 104, but at time 1512, V_{CC} is not zero or near zero, and is still near hysteretic steady state. However, upon startup of the PCC 104 at time 1512, the controller 220 immediately determines that a fast PING signal is being received on FB_SIGNAL_RX signal 1508, and thus instead of stepping through a sequence of unnecessary modes, the controller 220 proceeds directly to enabling the regulation mode 808, meaning the controller 220 provides hysteretic control to maintain V_{CC} within the target hysteresis band. As V_{CC} signal 1506 shows, V_{CC} rises modestly to return to hysteretic steady state and does not suffer overshoot, as is the case with other solutions described above.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

A device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

A circuit or device that is described herein as including certain components may instead be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be coupled to at least some of the passive elements and/or the sources to form the described structure either at a time of manufacture or after a time of manufacture, for example, by an end-user and/or a third-party.

Uses of the term “ground” in the foregoing description includes a chassis ground, an Earth ground, a floating ground, a virtual ground, a digital ground, a common ground, and/or any other form of ground connection applicable to, or suitable for, the teachings of this description. In this description, unless otherwise stated, “about,” “approximately” or “substantially” preceding a parameter means being within +/−10 percent of that parameter. Modifications are possible in the described examples, and other examples are possible within the scope of the claims.

As used herein, the terms “terminal,” “node,” “interconnection,” “pin,” and “lead” are used interchangeably. Unless specifically stated to the contrary, these terms are generally used to mean an interconnection between or a terminus of a device element, a circuit element, an integrated circuit, a device, or a semiconductor component.

What is claimed is:

1. A circuit, comprising:
a transformer including first and second windings forming an isolation barrier;
a first controller coupled to the second winding, a rectifier, and an output of the circuit, the first controller configured to generate a signal indicating a voltage on the output; and
a second controller coupled to the first winding and switches and separated from the first controller by the isolation barrier, the second controller configured to operate the switches to have a capped, variable duty cycle, to have an uncapped, variable duty cycle, or to maintain the voltage within a hysteresis band, responsive to the signal.

2. The circuit of claim 1, wherein the second controller is configured to, upon enablement of the circuit, determine a mode in which to operate the switches based on a frequency of a first component of the signal.

3. The circuit of claim 2, wherein the second controller is configured to operate the switches in a first mode to have the capped, variable duty cycle responsive to the frequency being at a first level.

4. The circuit of claim 3, wherein the second controller is configured to operate the switches in a second mode to have the uncapped, variable duty cycle responsive to the frequency being at a second level greater than the first level.

5. The circuit of claim 4, wherein the first controller is configured to set the frequency at the second level responsive to the voltage on the output exceeding a threshold.

6. The circuit of claim 4, wherein the second controller is configured to operate the switches in a third mode to maintain the voltage within the hysteresis band responsive to the frequency being at a third level greater than the first and second levels.

7. The circuit of claim 6, wherein the first controller is configured to set the frequency at the third level responsive to the voltage on the output reaching a target level.

8. The circuit of claim 6, wherein the second controller is configured to, when operating the switches in the third mode, turn the switches on responsive to a second component of the signal including a first pulse and a second pulse longer than the first pulse, the first and second pulses occurring within a target window of time, and to turn the switches off responsive to the second component of the signal including a third pulse longer than the first pulse, the third pulse occurring after the first and second pulses.

9. The circuit of claim 6, wherein the second controller is configured to skip the first mode, the second mode, or a combination thereof responsive to the determination.

10. A circuit, comprising:
switches coupled to a rectifier and a transformer, the rectifier coupled to an output of the circuit;
a voltage comparison circuit coupled to the output and configured to provide a first signal indicative of a voltage on the output with respect to a hysteresis band;
a first controller coupled to the voltage comparison circuit and configured to provide a second signal combining the first signal with a third signal indicating a status of the circuit; and
a second controller configured to:
determine a frequency of a first component of the second signal and operate the switches in one of multiple operation modes based on the frequency of the first component; and
when in a first mode of the multiple operation modes, operate the switches based on a frequency of and pulse widths of a second component of the second signal.

11. The circuit of claim 10, wherein the multiple operation modes include the first operation mode, a second operation mode, and a third operation mode, and wherein the second controller is configured to, responsive to the determination:
operate the switches in the first operation mode without first operating the switches in the second or third operation modes,
operate the switches in the second operation mode without first operating the switches in the first or third operation modes, and
operate the switches in the third operation mode without first operating the switches in the first and second operation modes.

12. The circuit of claim 10, wherein, to indicate the status of the circuit, the third signal indicates that the voltage on the output is within the hysteresis band.

13. The circuit of claim 10, wherein the first controller includes circuitry configured to generate the first signal, the circuitry including:
a first pulse generator having a first pulse generator input and a first pulse generator output, the first pulse generator input configured to be triggered by rising pulse edges;
a second pulse generator having a second pulse generator input and a second pulse generator output, the second pulse generator input coupled to the first pulse generator output and configured to be triggered by falling pulse edges, the second pulse generator output coupled to an input of an inverter;
a third pulse generator having a third pulse generator input and a third pulse generator output, the third pulse generator input coupled configured to be triggered by rising pulse edges;
an AND logic gate having an AND logic gate output and first and second AND logic gate inputs, the first AND logic gate input coupled to an output of the inverter, the second AND logic gate input coupled to the first pulse generator input, and the AND logic gate output coupled to the third pulse generator input;
a first OR logic gate having a first OR logic gate output and first and second OR logic gate inputs, the first OR logic gate input coupled to the first pulse generator output, the second OR logic gate input coupled to the third pulse generator output;
a fourth pulse generator having a fourth pulse generator input and a fourth pulse generator output, the fourth pulse generator input configured to be triggered by falling pulse edges and coupled to the first pulse generator input; and
a second OR logic gate having a second OR logic gate output and third and fourth OR logic gate inputs, the third OR logic gate input coupled to the first OR logic gate output, the fourth OR logic gate input coupled to the fourth pulse generator output.

14. The circuit of claim 10, wherein the first controller includes circuitry to generate the third signal, the circuitry comprising:
a first AND logic gate having a first AND logic gate output and first and second AND logic gate inputs, the second AND logic gate input being an inverting input;
a first delay circuit having a first delay circuit output, a first delay circuit input, and a first delay circuit reset input, the first delay circuit reset input being an inverting input and coupled to the first delay circuit input and the first AND logic gate output; and
a first pulse generator having a first pulse generator output and a first pulse generator input, the first pulse generator input coupled to the first delay circuit output and triggered by rising pulse edges, the first pulse generator output coupled to the second AND logic gate input.

15. The circuit of claim 10, wherein the second controller comprises:
a two-bit counter having a counter output and first and second counter inputs, the first counter input triggered by rising pulse edges, the second counter input is an enable input;
a pulse generator having a pulse generator output and a pulse generator input, the pulse generator input triggered by rising pulse edges and coupled to the first counter input, the pulse generator output coupled to the enable input;
a pulse width filter having a pulse width filter output and a pulse width filter input, the pulse width filter input coupled to the pulse generator input;
a first AND gate having a first AND gate output and first and second AND gate inputs, the first AND gate input coupled to the counter output, the second AND gate input coupled to the pulse width filter output;
a second AND gate having a second AND gate output and third and fourth AND gate inputs, the third AND gate input is an inverting input coupled to the counter output, the fourth AND gate input coupled to the pulse width filter output; and
a latch having a latch output and first and second latch inputs, the first latch input coupled to the first AND gate output and the second latch input coupled to the second AND gate output.

16. A computer-readable medium storing instructions which, when executed by a controller, cause the controller to:
determine a frequency of a first component of a signal in a power converter circuit, the first component indicating a status of a portion of the power converter circuit;
responsive to the frequency of the first component being at a first level, operate switches of the power converter circuit with an increasing duty cycle not to exceed a cap;
responsive to the frequency of the first component being at a second level, operate the switches with an increasing duty cycle not subject to a cap; and
responsive to the frequency of the first component being at a third level, operate the switches to maintain a voltage output of the power converter circuit within a hysteresis band and based on a frequency of and pulse widths of a second component of the signal.

17. The medium of claim 16, wherein the instructions cause the controller to turn on the switches responsive to receiving, within a target window of time and in the second component of the signal, a first pulse and a second pulse wider than the first pulse.

18. The medium of claim 17, wherein the instructions cause the controller to turn off the switches responsive to receiving, after the first and second pulses and in the second component of the signal, a third pulse wider than the first pulse.

19. The medium of claim 16, wherein the frequency of the first component being at the second level indicates the absence of a short circuit in the power converter circuit.

20. The medium of claim 16, wherein the instructions cause the controller to generate the first component of the signal to have the frequency at the second level responsive to the voltage output exceeding a threshold.
